(19) United States
(12) Patent Application Publication
(10) Pub. No.: US 2003/0028284 A1
(43) Pub. Date: Feb. 6, 2003

(54) Article identification

(76) Inventor: Munroe Chirnomas, Morris Township, NJ (US)

Correspondence Address: AUTOMATIC IMPULSE MACHINE DESIGN INC, LAWRENCE C EDELMAN, IP COUNSEL, 1 CORY RD, MORRIS TOWNSHIP, NJ, 07960, US

(21) Appl. No.: 09/998,989

(22) Filed: Nov. 29, 2001

Related U.S. Application Data
(60) Provisional application No. 60/257,316, filed on Dec. 21, 2000.
(60) Provisional application No. 60/261,964, filed on Jan. 16, 2001.
(60) Provisional application No. 60/294,284, filed on May 29, 2001.
(60) Provisional application No. 60/296,675, filed on Jun. 7, 2001.
(60) Provisional application No. 60/206,363, filed on May 23, 2000.

(51) Int. Cl. G06F 17/00

(52) U.S. Cl. 700/231

(57) ABSTRACT

The present invention relates to improvements in the design and operation of an article dispensing apparatus used in conjunction with an article identification device, and is particularly useful in the environment of a vending machine. A user interface and control portion of the dispensing apparatus allows a user of the apparatus to initiate an article dispensing operation and cause controlled movement of an article handling device so that a selected article is moved from an article storage area along a common path to a dispensing area of the dispensing apparatus. The article identification device is operated so as to generate data which identifies the handled article before, during or after it moves along the common path. In accordance with a further aspect of the invention, the dispensing apparatus is disabled, directly or indirectly, in response to article identification data. Furthermore, re-enablement, or prevention of disabling of the dispensing apparatus, directly or indirectly, in response to data acquired using the article identification device, is also contemplated. Business methods in accordance with such disabling are also contemplated, wherein inoperability of the apparatus is used as an enforcement mechanism to stimulate adherence by an operator or owner of the apparatus to predetermined rules.

### CROSS-RELATED APPLICATIONS

This application claims priority of and is a continuation in part of: (i) PCT/US01/16853, filed May 23, 2001, entitled METHOD AND APPARATUS FOR INCLUDING ARTICLE IDENTIFICATION IN AN ARTICLE HANDLING DEVICE; (ii) PCT/US01/16893, filed May 23, 2001, entitled METHODS OF DOING THE BUSINESS OF MACHINE VENDING (which claims the benefit of U.S. Provisional Patent Application No. 60/257,316, filed Dec. 21, 2000, entitled METHOD AND APPARATUS FOR ARTICLE HANDLING, SUCH AS FOR A VENDING MACHINE); (iii) PCT/US01/16837, filed May 23, 2001, entitled METHOD AND APPARATUS FOR CONTROLLING A VENDING MACHINE; (iv) PCT/US01/16847, filed May 23, 2001, entitled METHOD AND APPARATUS FOR STORING ARTICLES FOR USE WITH AN ARTICLE HANDLING DEVICE; (v) PCT/US01/16846, filed May 23, 2001, entitled METHOD AND APPARATUS FOR HOSE STORAGE IN AN ARTICLE HANDLING DEVICE; (vi) PCT/US01/16894, filed May 23, 2001, entitled METHOD AND APPARATUS FOR POSITIONING AN ARTICLE HANDLING DEVICE, all of the above patent applications claim the benefit of U.S. Provisional Patent Application No. 60/206,363, filed May 23, 2000, entitled METHOD AND APPARATUS FOR ARTICLE HANDLING, SUCH AS FOR A VENDING MACHINE.

This application also claims priority of and is a continuation in part of (vii) International Publication No. WO 01/11578, filed Aug. 7, 2000, entitled VENDING MACHINE (which claims the benefit of U.S. Provisional Patent Application No. 60/147,832, filed Aug. 7, 1999, entitled VENDING MACHINE), and (viii) its corresponding U.S. application Ser. No. 09/633,477. (ix) U.S. Provisional Patent Application No. 60/257,316, filed Dec. 21, 2000 and entitled METHOD AND APPARATUS FOR ARTICLE HANDLING, SUCH AS FOR A VENDING MACHINE; and (x) U.S. Provisional Patent Application No. 60/261,964, filed Jan. 16, 2001 and entitled METHOD AND APPARATUS FOR ARTICLE HANDLING AND DISPENSING DEVICES; (xi) U.S. Provisional Patent Application No. 60/294,284, filed May 29, 2001, entitled METHOD AND APPARATUS FOR QUICK CHANGE DISPLAY GRAPHICS ON A MERCHANDISER; and (xii) U.S. Provisional Patent Application No. 60/296,675, filed Jun. 7, 2001, entitled METHOD AND APPARATUS FOR ARTICLE HANDLING, SUCH AS WITH A VENDING MACHINE.

This application also claims priority of and is a continuation in part of: (xiii) U.S. Provisional Patent Application No (attorney docket #01PR19US) filed Nov. 23, 2001 in the name of Munroe Chirnomas and entitled MACHINE FOR VENDING ARTICLES AND METHODS ASSOCIATED THEREWITH, and of (xiv) U.S. Provisional Patent Application No (attorney docket # 01PA20US) filed Nov. 23, 2001 in the name of Munroe Chirnomas and entitled METHOD AND APPARATUS FOR VENDING GOODS. The entire disclosures of all of the above patent applications are incorporated herein by reference, at least for US purposes.

### DETAILED DESCRIPTION

The following descriptive material is for use in combination with the descriptions in the attached EXHIBITs, in order to further describe and/or clarify various features and aspects of the invention.

In the attached EXHIBIT A (corresponding substantially to the forenoted PCT/US01/16853, but including minor Formal corrections, such as changes in numerals so as to accommodate the new/changed Figure numbers) description in accordance with several aspects of the invention, consider that the Brief Description Of The Drawings at page 6 also states:

“FIG.'S 5 and 6 illustrate details of the carriage portion of the article handling mechanism shown in FIG.'S 2 and 3.

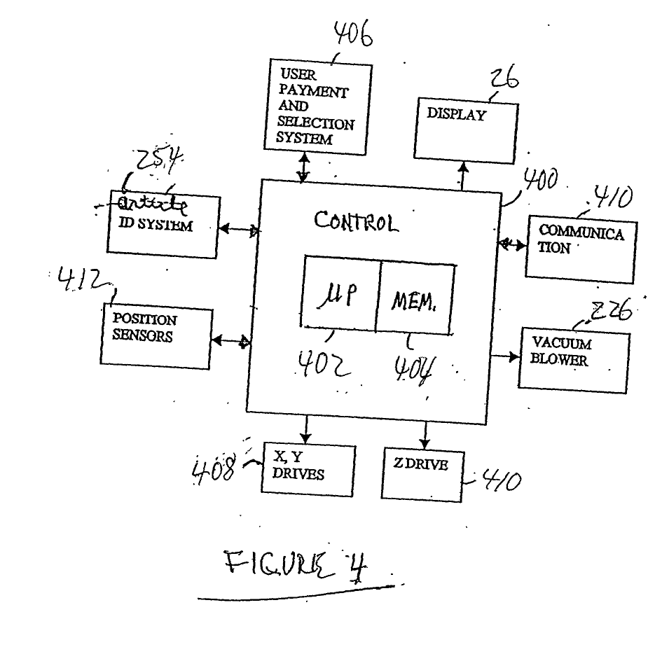

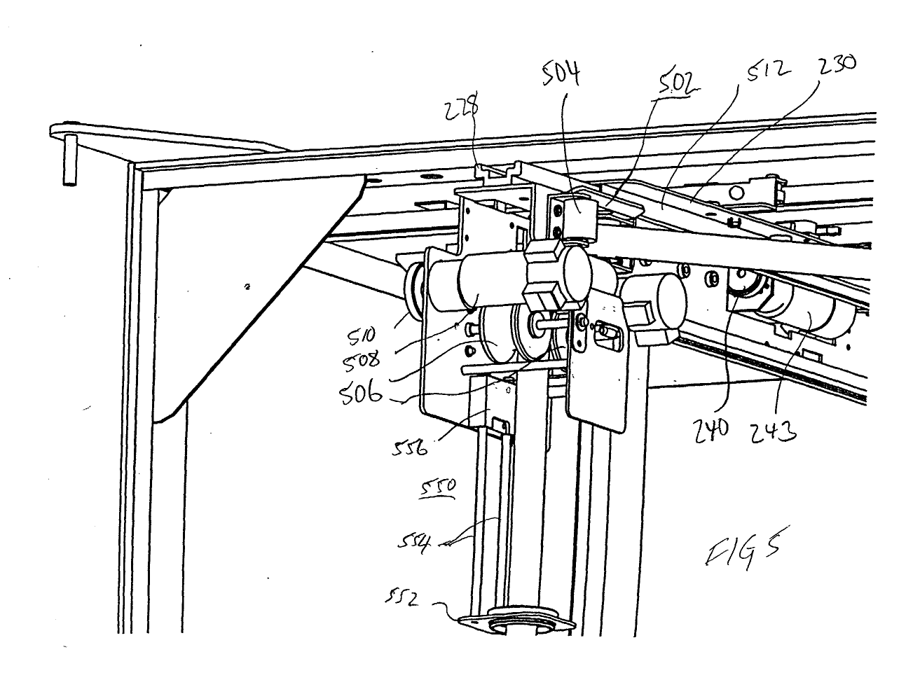

FIG. 7 illustrates details of the hose guidance mechanism shown in FIG.'S 2 and 3, and FIG.'S 8, 9, 10, 11 and 12 illustrate combinations/orientations of various article handling mechanisms and storage areas.”

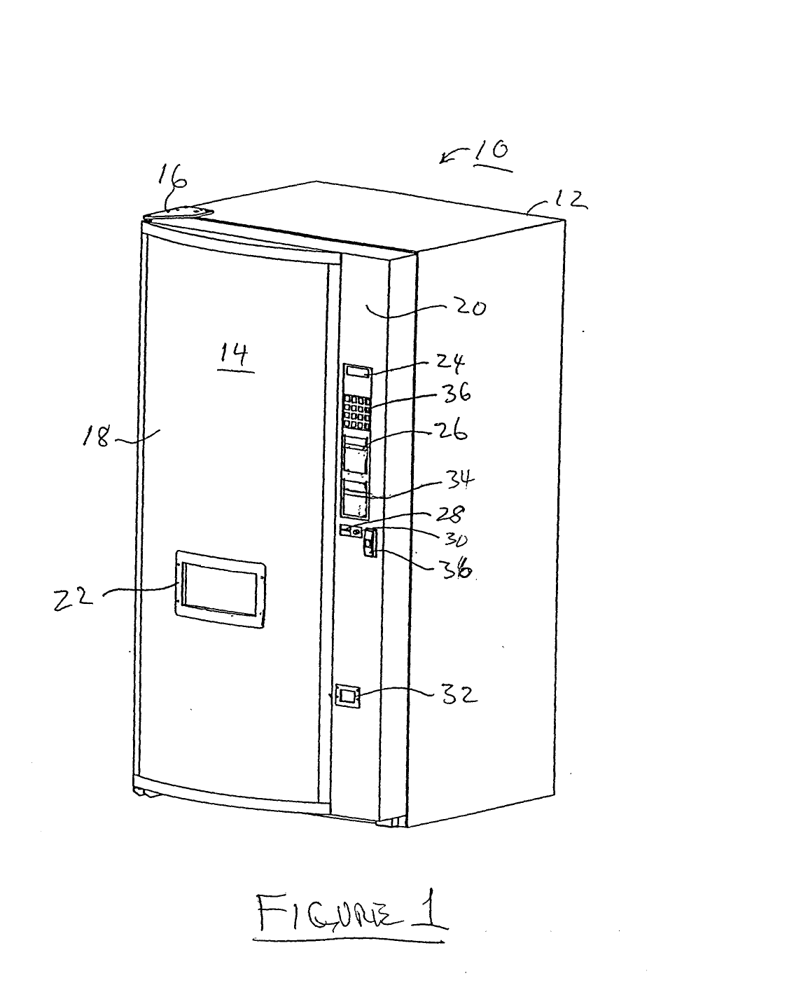

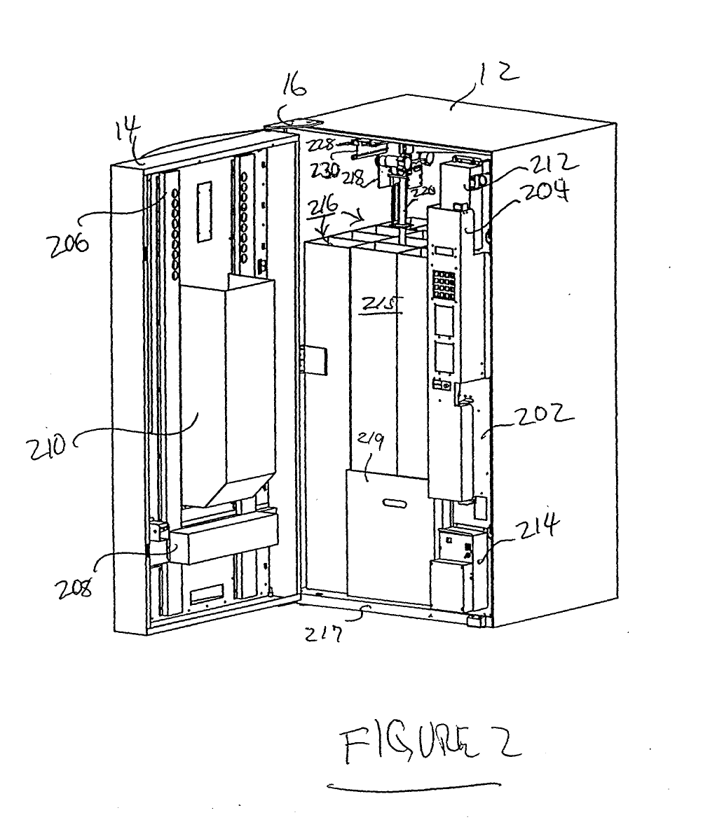

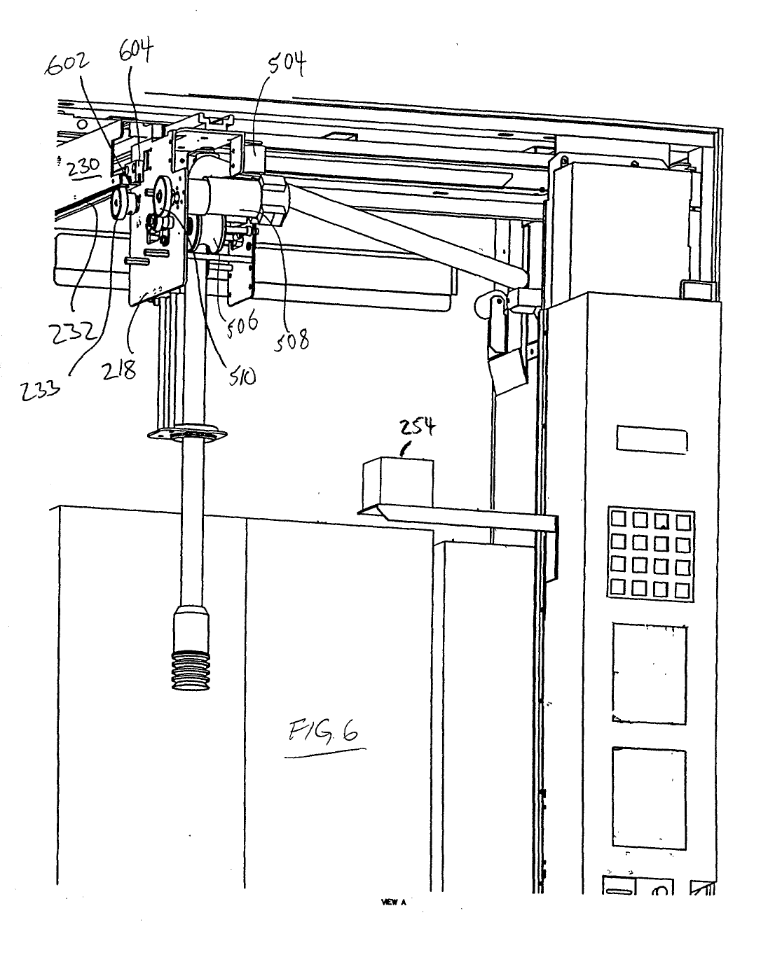

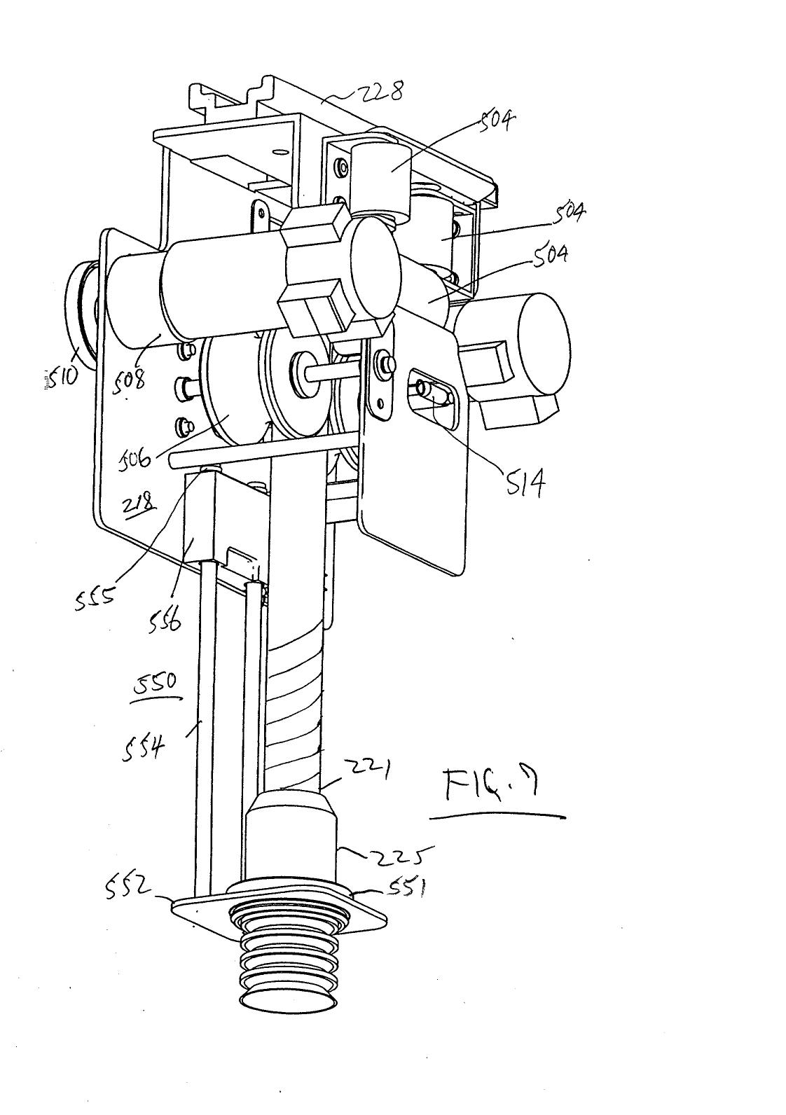

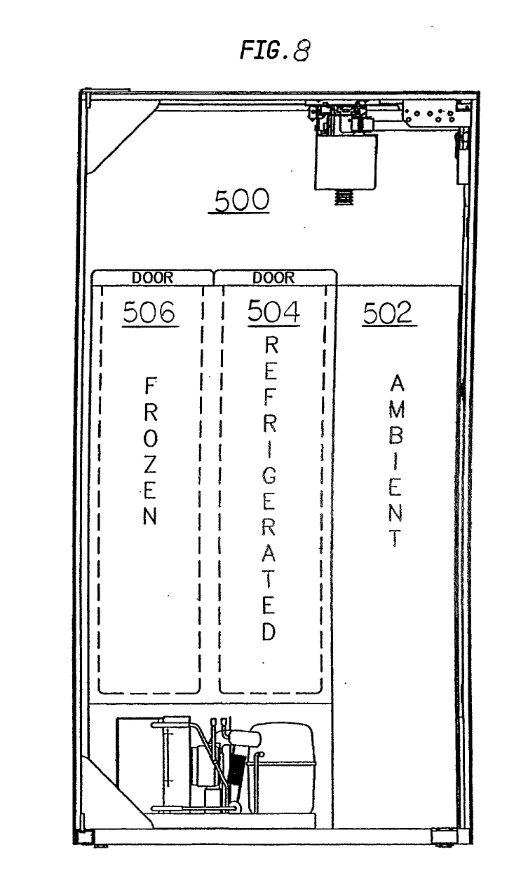

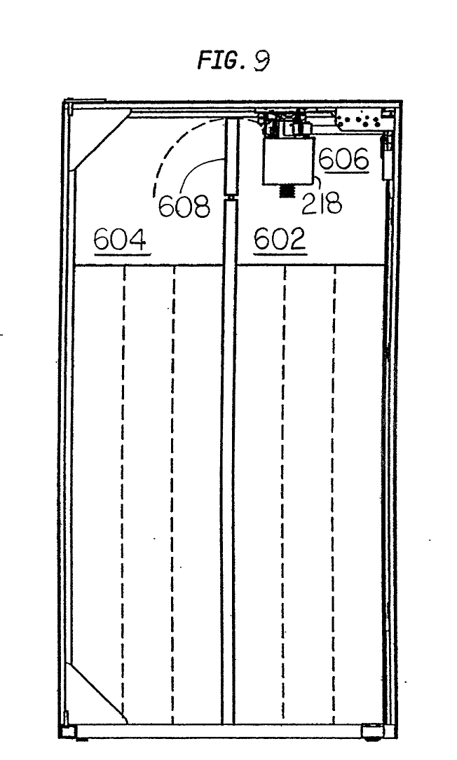

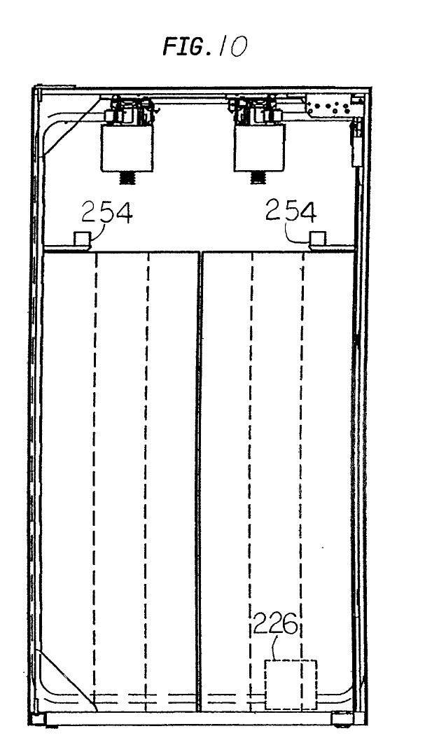

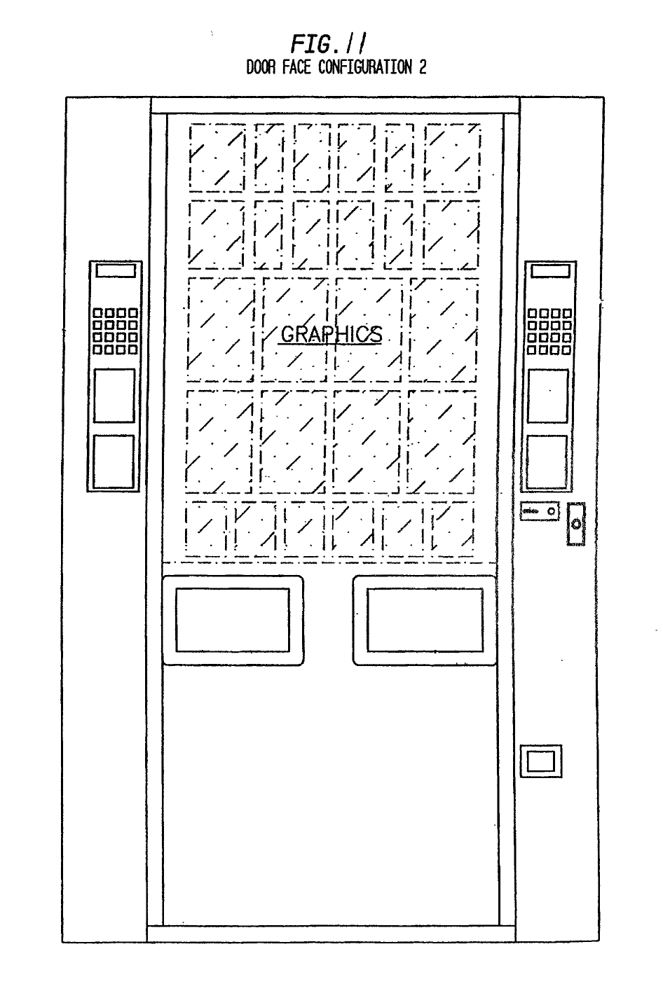

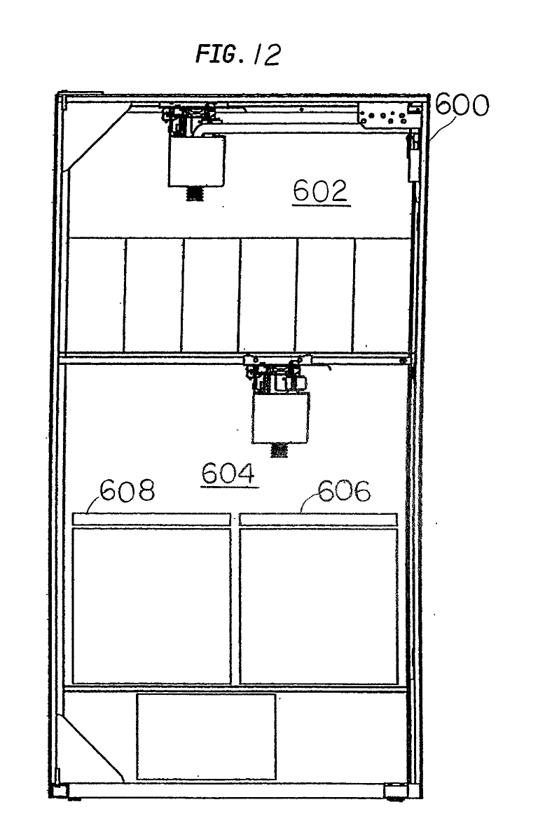

In accordance with the above, new FIGS. 8-12 follow these pages, which FIGS. 8-12 are already described at pages 16-18 of the EXHIBIT A, but erroneously referred to as FIGS. 5-9, respectively.

It is noted that article identification in accordance with several aspects of the present invention find use in vending apparatus and methods of operation of vending apparatus such as described in the attached EXHIBIT B description (corresponding substantially to the forenoted U.S. Ser. No. (attorney docket # 01PR20US) filed Nov. 23, 2001), and also apply as well to vending apparatus having the configurations and methods such as described in the attached EXHIBIT C (attorney docket #01PR19US) description, alone or in combination with the teachings of EXHIBIT B. Application and/or modification of the methods and apparatus shown in the Exhibits, by one of the ordinary skill in this technology, and then applied to the invention described herein, is intended to be within the scope of this invention and any claims that issue herefrom.

It is also noted that in accordance with one aspect of the present invention, an article dispensing apparatus comprises

a storage volume,

an article extracting device for extracting an article from the storage volume,

control apparatus for allowing a user of the dispensing apparatus, either directly or indirectly, to initiate an article dispensing operation, and to cause controlled movement of the article extracting device so that a selected article is extracted from the article storage area and moves along a path to a dispensing area, and

an article identification device, mounted within the dispensing apparatus, and operated so as to provide identification of an article before, during or after it moves along the path to the dispensing area.

In accordance with a further aspect of the invention, and as described in greater detail below, disabling of the dispensing apparatus, directly or indirectly, in response to data acquired using the article identification device, is contemplated hereby. Furthermore, re-enablement, or prevention of disabling of the dispensing apparatus, directly or indirectly, in response to data acquired using the article identification device, is also contemplated.

Business methods in accordance with such disabling is also contemplated, wherein inoperability of the apparatus is used as an enforcement mechanism to stimulate adherence by an operator or owner of the apparatus to predetermined rules.

In accordance with a still further aspect of the invention, the article identification device is mounted within the dispensing apparatus along a common path taken by the articles as they are moved to the dispensing area. Article identification during dispensing, as compared with, for example, article identification when loading, helps insure that the article identification is truthful.

In accordance with an even further aspect of the invention, a positioning mechanism is coupled to the article extracting device and responsive to control signals for positioning a free end of the device in alignment with a selected longitudinal axes of the storage volume where the articles are stored in row or columnar form, either vertically, horizontally, or at any angle therebetween.

A drive mechanism may be coupled to the article extracting device for moving the free end of the article extracting device in a direction aligned with the longitudinal axes in the storage volume, and thereafter in a predetermined pattern adjacent to the article identification device.

In the above arrangement, the article identification device may use optics to provide article identification, and is controlled to image or scan the articles when they move in the common path.

Any suitable design and implementation of the article ID device 254 may be employed without departing from the spirit and scope of the present invention. For example, the article ID device 254 may employ one or more of an optical technology, such as a bar code scanner(for reading a unique article ID, e.g., a UPC code, preprinted on the goods), an image recognition system, an analog and/or digital still camera, an analog and/or digital video camera. Alternatively, the article ID device 254 may employ electromagnetic technology, such as a radio frequency identification transponder (RFID) or a magnetic reader for article identification using electromagnetic tags included with the goods. Further details concerning suitable implementation hardware for article ID device 254 may be found at www.aimglobal.org, a website of the global trade organization, AIM. This website provides many details concerning article identification and data collection (AIDC).

The article ID device 254 is preferably mounted within the cabinet 12 at a substantially fixed location such that the goods stored in the storage area 215 may be scanned as they are moved from the compartments 216 to the dispensing chute 210 by the electromechanical retrieving device 200 (218, 220, 221, 224, 227, 228 and 230 of e.g., EXHIBIT A or B). Alternatively, the article ID scanning may take place before or after such goods dispensing movement. Further, the article ID device 254 may be mounted on the carriage 218 and/or on the free end 221 of the air hose 220. Preferably, only a single article ID device 254 is employed when the electromechanical retrieving device 200 discussed above is used to move the goods from the storage area 215 to the dispensing chute 210. Indeed, the electromechanical retrieving device 200 described herein is preferably operable to move the article 223 past the article ID device 254 to obtain a scan of any of the goods stored in the storage area 215. Details concerning the types of information gleaned from such scanning and uses thereof is discussed more fully below and in EXHIBIT B.

ID device 254 may be used, either directly or indirectly, in the determination of prescribed data, which data may include at least one of:

(i) a quantum of one or more types of goods sold during one or more predefined periods of time;

(ii) a quantum of one or more brands of goods sold during one or more predefined periods of time;

(iii) a ratio of one or more types of the goods sold to one or more other types of the goods sold in a predefined period of time;

(iv) a ratio of one or more brands of the goods sold to one or more other brands of the goods sold in a predefined period of time;

(v) respective dates of vends (and/or attempted vends) from the vending apparatus;

(vi) respective times of vends (and/or attempted vends) from the vending apparatus;

(vii) information concerning whether a particular good was out of inventory;

(viii) information concerning what a next choice of goods was made by a purchaser when a particular good was out of inventory;

(ix) information concerning whether the vending apparatus was operational;

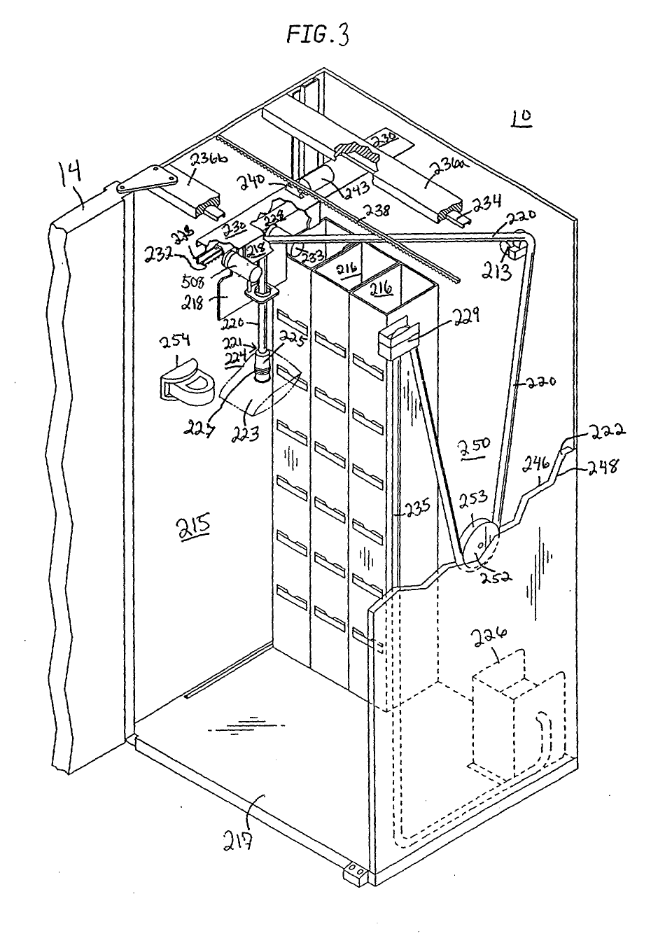

For example, ID device 254 may be used to monitor information concerning the sales of goods from the vending apparatus, and more specifically, in one embodiment, used in the determination of whether authorized goods are being sold from the vending apparatus 10. The article ID device 254 is preferably operable to obtain at least some of the above listed information by scanning the articles 223 and providing data to the microprocessor 402 of the control system 400 (FIG. 6 of EXHIBIT B). In an embodiment where the article ID device 254 includes a bar code scanner, the UPC code on the article 223 may be analyzed to determine the type, the brand, the size, the weight, the expiration data, the package type, the period of manufacture, the place of manufacture, etc. of the goods being vended. This data may be at least temporarily stored in the memory 404 of the control system 400.

One skilled in the art will appreciate that these raw data are suitable for use, in accordance with one aspect of the invention, in determining whether unauthorized goods are being (or have been) vended from the vending apparatus 10. These raw data may be released (as prescribed data) from the vending apparatus 10, e.g., via the communications unit 410, for an externally conducted determination. Preferably, however, the vending apparatus 10 is operable to make the determination as to whether unauthorized goods are being (or have been) vended and, therefore, is operable to determine whether a contractual obligation relating thereto has been met. Thus, the prescribed data may include one or more of the final data as to whether unauthorized goods are being (or have been) vended and, further, whether any contractual obligation relating thereto has been met.

As noted above, disabling of the vending apparatus 10, directly or indirectly, in response to data acquired using the article ID device 254, is contemplated hereby. Furthermore, re-enablement, or prevention of disabling of the vending apparatus 10, directly or indirectly, in response to data acquired using the article ID device 254, is also contemplated hereby.

For example, in the event that unauthorized goods are being (or have been) vended from the vending apparatus 10, the vending apparatus 10 may be partially or wholly shut down or prevented from further vending/dispensing, as described in detail in EXHIBIT B. Such knowledge of which products are unauthorized may be pre-programmed into the vending apparatus 10 and stored therein in a manner which it can not be tampered with. In this regard, in one embodiment, the vending apparatus 10 preferably includes an electronic means for sensing whether unauthorized removal and/or altering of the various parts thereof, such as control system 400 and/or the peripheral circuits/systems has occurred. Further discussion of such electronic means is provided in greater below.

In accordance with a further aspect of the invention, compliance with a contractual obligation, for example to maintain inventory of one or more goods in the vending apparatus 10, is preferable determined from data acquired by the vending apparatus 10 via article ID device 254. To this end, the vending apparatus 10 is preferably operable to monitor one or more parameters concerning the inventory of one or more goods stored therein and collecting the prescribed data (whether in final form or in raw data form, from which the final data may be computed and/or generated).

The control system 400 in combination with the electromechanical retrieving device 200 and article ID device 254, may be capable of conducting an inventory action on the goods stored within the vending apparatus 10. In one embodiment, the electromechanical retrieving device 200 may be commanded by the control system 400 to remove goods to be inventoried from their positions within the storage area 215 (and to hold them temporarily in an alternative location within the storage area 215, if necessary) while the control system 400 in combination with the article ID device 254 counts the quanta of goods of a particular type, brand, size, weight, expiration data, package type, period of manufacture, place of manufacture, etc.

It is noted that the above described article identification for purposes of, for example, determining dispensing of authorized goods and/or maintenance of a prescribed inventory, does not require article identification for each and every article which is dispensed. That is, the article identification can be done in a random “skipping” manner, i.e. scanning less than at each and every vend, and even furthermore article identification can be done in a predetermined “skipping” manner which uses statistical analysis (interpolation) in order to determine compliance with a prescribed obligation. Furthermore, the control portion of the apparatus may allow a limited number of dispensing operations in the event that article identification is not successful and may even allow a limited number of dispensing operations even if a prescribed obligation is not met. In this case the control portion of the apparatus may allow the dispensing operation to continue for a predetermined number of cycles after an unsuccessful or unauthorized article identification, before disabling the apparatus.

An article dispensing apparatus which takes particular advantage of this concept may comprise,

an article storage volume which stores articles to be dispensed in predetermined article storage compartments, where there is requirement that articles of different types not be stored in the same article storage area

an article retrieving device which moves selected articles from the storage volume to a customer retrieval area

an article identification device which identifies articles before, during or after they are moved from the storage volume into the customer retrieval area, and

a graphics display associated with the dispensing apparatus, which graphics display provides article selection information to a user of the dispensing apparatus,

wherein the user is unable to see the actual articles in the storage area and must rely on the graphics display for article selection.

In such an arrangement, in the event that there is and obligation to only dispense authorized products, the controller portion of the article dispensing apparatus is not required to have the ability to identify each and every dispensed article, since the controller can assumed that the operator has filled the storage compartments properly. That is, if the storage compartments were not filled properly, the user would not receive the desired article, and such disappointments would greatly reduce use, and consequently profits, from that dispensing apparatus.

Indeed, as discussed above, the article ID device 254 may be used to obtain at least some of the above listed information by scanning the articles 223 and providing data to the microprocessor 402 of the control system 400. For example, when the article ID device 254 includes a bar code scanner, the UPC code on the article 223 may be analyzed to determine the type, the brand, the size, the weight, the expiration data, the package type, the period of manufacture, the place of manufacture, etc. of the goods being maintained in the vending apparatus 10. This data may be at least temporarily stored in the memory 404 of the control system 400.

In this way, raw data may be obtained to determine whether prescribed inventories are being maintained. These raw data may be released (as prescribed data) from the vending apparatus 10, e.g., via the communications unit 410, for an externally conducted determination. Preferably, however, the vending apparatus 10 is operable to make the determination as to whether prescribed inventories are being maintained and, therefore, is operable to determine whether the contractual obligation relating thereto has been met. For example, information concerning what the one or more prescribed inventories must be may be stored in the memory 404 of the control system 400. The microprocessor 402 of the control system 400 is preferable operable to compare the one or more prescribed inventories with the raw data relating to the actual inventories being maintained in the vending apparatus 10. The result of the comparison yields the final data, e.g., the determination as to whether the one or more prescribed inventories are being maintained. Further, the result may yield other final data, such as whether the contractual obligation relating to whether the one or more prescribed inventories are being maintained has been met.

The discussion immediately above has substantial applicability to determining whether the obligation to maintain a prescribed ratio of space occupied by one or more goods stored in the vending apparatus 10 to the storage space available within the vending apparatus 10. Indeed, the space available within the vending apparatus (e.g., the size of the storage area 215) is available to the microprocessor 402, for example, by way of the memory 404, then the data obtained via the inventory operation conducted by the control system 400, the article ID device 254, and the electromechanical retrieving device 200 may be: (i) released by the vending apparatus (e.g., via communications unit 410) for and external determination; (ii) used to internally compute (e.g., via the microprocessor 402) the actual ratio of space occupied by one or more goods stored in the vending apparatus 10 to the storage space available; (iii) used to determine whether the prescribed ratio is being maintained within the vending apparatus; and/or (iv) whether the contractual obligation relating to the prescribed ratio has been met.

One skilled in the art will appreciate that this raw data may be utilized to determine whether the prescribed ratio of one or more of the goods to one or more others of the goods have been sold from the vending apparatus 10, or other information, such as determining whether a prescribed quanta of money was received at the vending apparatus 10 in a predefined period of time.

The concept of at least partially disabling the vending apparatus 10 from dispensing at least some of the goods stored therein has been discussed above (see also FIGS. 7-12 of EXHIBIT B) and will be further considered hereinbelow. It is noted that those skilled in the art will appreciate from the disclosure herein that the particular mechanism and/or process for disabling the vending apparatus 10 may vary. A determination as to whether the vending apparatus 10 should be disabled may be made externally (e.g., via an external computer system) or internally (e.g., via the control system 400) and a corresponding external and/or internal disable signal generated to cause the vending apparatus 10 to become at least partially disabled. For example, the control system 400 may prevent the electromechanical retrieving device 200 from moving to the X, Y position of one or more of the containers 216. Alternatively, the control system 400 may prevent the air hose 220 from moving into contact with the article 223 and/or may prevent vacuum action when the X, Y positions of the carriage 218 corresponds to a container 216 that contains goods that are “disabled” from being vended. Another alternative way to disable the dispensing of goods may include requiring that the retrieving device 200 return the article 223 to the storage area 215 instead of placing it in the dispensing chute 210. A further alternative may be to disable the dispensing chute 210, the bill acceptor mechanism 26, the coin acceptor mechanism 28, the card acceptor mechanism 34, etc. Still further, one or more motors and/or electromechanical devices may be disabled.

In one embodiment, a condition that triggers the desirability to at least partially disable the vending apparatus 10 may occur and the timing of actually disabling the vending apparatus 10 may occur anytime afterwards (e.g., after a current vend is completed as opposed to prohibiting the current vend to complete). The condition may be the detection by the article ID device 254 that an unauthorized good has been detected and the at least partial disablement may be prohibiting further vending from the corresponding compartment 216.

It is noted that an unscrupulous party may be motivated to attempt to alter the nature of the vending apparatus 10 such that it will not at least partially disable in accordance with the invention as described in the embodiments herein. For example, if the function of partly or fully disabling the vending apparatus 10 is carried out by way of a software program running on the microprocessor 402 platform of the control system 400 as discussed above, then an unscrupulous party may seek to remove the control system 400 from the vending apparatus 10 and replace it with a substitute control system that does not disable the vending apparatus 10.

In order to thwart the unauthorized modification of one or more components of the vending apparatus 10, the vending apparatus 10 preferably includes at least one of an electronic, an electromechanical, and/or a mechanical means for sensing whether an unauthorized modification of the vending apparatus 10 has occurred and, if so, at least partially disabling the vending apparatus 10 from dispensing goods. To that end, the control system 400 and/or the peripheral systems/circuits preferably include an electronic security circuit that is operatively coupled to, or in operative communication with, a receiving circuit such that unauthorized removal and/or alteration of the control system 400 and/or the peripheral systems/circuits may be sensed by the receiving circuit. The electronic security circuit 50 may produce a unique code that when received indicates an authorized removal and/or the alteration of the vending apparatus 10. Any of the known electronic security circuits may be utilized to implement the electronic security circuit 50, such as a MicroChip encryption security chip. Alternatively, the circuit 50 may be a radio frequency identification (RFID) tag (with corresponding reader) as may be obtained, for example, from Motorola of San Jose, Calif. As is known in the art, the electronic security circuit 50 preferably communicates with the receiving circuit (or circuits) by way of hard wire, wireless communication, etc. and preferably utilizes encryption. Further details concerning suitable implementation hardware for the electronic security circuits 50 may be found at wvw.aimglobal.org, a website of the global trade organization, AIM. In this regard, it is also noted that in the event the apparatus is disabled due to tamper sensing, even if the tampered component(s) are properly replaced, before the dispensing apparatus again becomes operative, a re-enable code may be required.

The following numbered paragraphs supplement the above description:

1. A dispensing apparatus including an ID device operable to scan each article of goods that is dispensed from the apparatus and which ID device provides information to a processing unit of the dispensing apparatus as to whether a limitation is either met or violated, wherein the limitation is one of:

that the vending apparatus is required to vend only authorized goods,

that the vending apparatus authorized to only vend a certain dollar amount of sales,

that the vending apparatus is authorized to only vend a certain number of products,

wherein the above authorizations are to be considered alone, or in combination with, a predetermined time interval.

2. The apparatus of paragraph 1, wherein the article ID device includes at least one of a bar code scanner (reader), an optical reader, an image recognition system, an analog and/or digital still camera, an analog and/or digital video camera, a radio frequency identification device, and a magnetic reader.

3. The apparatus of paragraph 1, wherein the processing unit is further operable to enable the apparatus for sequential intervals of operation, so long as respective continuation codes are received by the apparatus for each interval, and wherein no two sequential continuation codes are identical.

4. The apparatus of paragraph 1, wherein the processing unit is further operable to automatically enable the apparatus after a predefined period of time has elapsed after the apparatus has been disabled.

4′. The apparatus of paragraph 1, wherein the disabling of said dispensing is overcome, or re-enabled, in response to input to the processing unit of an encoded authorizing signal.

4″. The apparatus of paragraph 1, wherein the, wherein disabling of said dispensing is overcome, or re-enabled, in response to the passage of time.

5. The apparatus of paragraph 1, wherein the article identification device comprises an imaging system, such as an analogue or digital, still or video, camera, coupled to an image analysis device that recognizes predetermined images (color/pattern or texture, etc.) thereby providing the article identifications.

6. The apparatus of paragraph 1, wherein a drive means causes the article extracting device to perform a discontinuous movement in the area of the article identification device, as the article moves from the article storage area to the dispensing area. This movement is controlled for the purpose to facilitated an improved “view” of the article by the article ID device.

7. The apparatus and a business method in accordance with paragraph 1, wherein the article identification is used by a user interface and control apparatus for making all or part of the apparatus inoperable.

8. A business method in accordance with paragraph 7, wherein partial inoperability of the apparatus prevents dispensing of articles from at least one portion of the storage volume.

9. A business method in accordance with paragraph 7, wherein inoperability of the apparatus is used as an enforcement mechanism to stimulate adherence by an operator or owner of the apparatus to predetermined rules.

10. A business method in accordance with paragraph 7 or 9, wherein inoperability of the apparatus is used as an enforcement mechanism to stimulate reporting of sales and inventory data to a central authority.

11. A business method in accordance with paragraph 7 or 9, wherein inoperability of the apparatus is used as an enforcement mechanism to stimulate adherence to plan-o-grams (proper article layout by person stocking the apparatus with article, i.e., the route driver).

12. A business method in accordance with paragraph 11, wherein an incentive or bonus is provided to the route driver for adherence to the plan-o-grams.

13. A business method in accordance with paragraph 12, wherein the apparatus includes an optional interior display so the route driver can monitor the bonus or incentive program.

14. Apparatus in accordance with paragraph 1, wherein in the event that a specific article is not successfully identified, the vending apparatus is able to interpolate/assume the article id of that specific article based on the successful id of other articles which have previously been identified and which were stored and retrieved from a same predetermined portion of the storage volume as where the unidentified article was retrieved from.

In the above described apparatus, it was noted that the article identification device is mounted within the dispensing apparatus along a common path taken by the articles as they are moved to the dispensing area. Accordingly, the article retrieving device may be controlled to make a predetermined pattern of movement, i.e. repositioning, in the area of the article identification device, in an effort to aid the article identification, such as the movement noted in paragraph 6 above. In this regard, such movement may comprise a sudden jostling type of movement, which may be useful, for example, to smooth out the wrinkles in a flexible bag, and thereby make its bar code more easily identifiable, or pattern such as would provide multiple opportunities for the article ID device to scan the article. Even furthermore, the control system of the dispensing apparatus may “learn” from repeated patterns and the success of their results, so as to provide improved patterns for future dispensing which would result in a greater percentage of the articles being successfully scanned.

15. Apparatus as described in the first of the above noted aspects of the invention, whereby an article stored in the storage volume can be identified by the article id system:

By removing the article from the storage volume and moving the article adjacent to an identification area where the article can be identified, such moving being made by a conventionally known spiral mechanism or by a robot device,

Prior to the article coming to rest in an article retrieval area, or

Prior to article being placed back in that portion of the storage volume of origin, or

Prior to the article moving to a different portion of the storage volume, or

Within the article retrieval area.

See also the attached description on pages marked 4-8.

The ID system, preferably a vision system, can be used to inspect a package for damage or other defects or reasons to reject vending it. This operation and other uses of the ID system using a bar code reader or other device and their related monitoring procedures may be beneficially operable in between dispensing cycles and are not restricted only to working during a vend cycle.

After inspection or identification by the ID device, an article may then be vended, or placed back into the storage bin or compartment from which it was retrieved, or still further my be placed into a holding area, for example for the purpose of inspection by a person at a later point in time.

Images from the camera or video camera mounted within the housing or cabinet can be displayed on a display screen or video monitor, which may be visible to the user. In this way, a user may be able to see the operation of the machine while still not easily being able to break a glass window, such a window would otherwise be necessary for viewing purposes typical in a spiral vending machine. Images of the operation or condition of the machine may also be transmitted or stored and communicated electronically, for example over the internet or another communication network to a remote site where a person could use the camera, especially if the camera is mounted on a remote controlled mounting, to inspect for damage to the machine, to troubleshoot or diagnose a technical problem, or simply view any other aspect of the inventory details or performance of various parts of the apparatus. A camera may also be used to capture images of vandals who approach the machine, or who gain access to the machine. Images may be stored electronically at the location of the machine or at a remote site, using either the computer control system of the apparatus, or a separate computer system which may be located within the apparatus or remote to the apparatus.

The information gathered from the control system and or the ID device may be used to enable software in a computer system to calculate parameter which at least a partially is utilized in order to determine the pay or compensation of at least one person or entity such as a route person who loads the machine or a managing entity which is responsible for maintaining the equipment to a specified standard.

In an embodiment where the dispensing apparatus is a spiral vending machine, the camera, optics, RF or other device or multiple devices may be strategically located at or near the customer retrieval area, where the ID device may identify the article as it is falling or after it has fallen into the retrieval area. Advantageously, at least one camera may be mounted in a position so as to be able to view multiple articles when they are still within the storage compartments, on the shelves, or in the bins and therefore, the camera can be used to identify any one of multiple articles which have been stored in one of several storage locations. The camera, lens or ID device in this embodiment can further be operable to move and thereby change its viewing angle in order to allow the control system to guide the view of the storage area or article desired to be viewed. As described before, this ID monitoring may be utilized before, during, or after the occurrence of a vend cycle. In the embodiment of a horizontal shelf machine, such as with bins on horizontal shelves and a robot or in the case of horizontal shelves with spiral dispensers mounted within, the camera or ID device or devices may be mounted facing and or opposing the face of the articles sitting on the shelves. In the case where the article dispensing includes a conveyor belt or other conveyance is required in order for the article to be transferred to the customer retrieval area, the camera or ID device may be mounted at one end of the conveying path or anywhere along the conveying path.

The control system may have accessible stored within it, or stored remotely from it, data which specifies the type of parameters such as bar codes that are acceptable or authorized to be within or in use by the machine. The computer system is operable to makes a comparison between the data stored in the computer memory and the data being monitored from within the machine or relating to the machine. At that point the control system is able to make a determination of what, if any, further action or inaction needs to taken.

The control system may also operate the robot to automatically search for a specific article using the robot and the ID device. The computer can operate the robot to remove articles from the bins, or in another embodiment use a camera and vision or optical recognition software, in order to study the articles in their storage areas without the need for removal. Still further the control system may use the learned information to automatically update inventory, restrict certain articles from sale, reconfigure a user display which displays graphics or identifications of the articles stored within a storage area.

Some aspects of the present invention may also be embodied by mounting the ID device onto the retrieval system, such as mounting the ID device onto the end of the hose. In the case of a RF transmitting device, for example, the wires for the device, mounted on or near the end of the hose, can travel through the hose. The ID device could also be mounted to other points on the positioning mechanism in order to get a good viewing position. For example, the camera or ID device may be mounted to the x-y carriage (or in a horizontal embodiment, the x-y shelf) so that the control system can move the camera and position it in order to inspect and identify the articles stored in the compartments, shelves or bins.

The control system may be operable to move the positioning system while searching for an identification of an article and continue the various motions until the identification is made or alternately until some preset time limit has been reached.

The robot and control system can “learn” to improve speed and accuracy of locating the bar code or identifying mark of a given type of package by “learning” the specific features of the package either by having that intelligence preprogrammed about a specific package, or by cumulative learning by trial and error.

The optical scanner or the camera can also be used to identify an article based on a logo, artwork, or package color.

The ID device can be used to identify many types of parameters of an article. This is enhanced by having coded information attached to the article, such as in an ID tag or in a bar code etc.

The ID device search for an article parameter can be operable as a random event for audit purposes where the unit doesn't have to scan every package.

The ID device and the control system can interpolate where the assumption is made, that if a code can not be discerned the machine will still vend and look for an average number of successful scans from a specific storage compartment. So a limited number of vends may be allowed to occur in a compartment even if no product ID can be found, or further, a limited number of vends can be vended even if the article has the wrong code after an allowed number of failed attempts to get an authorized parameter the control system may then, for example, disable access to a specific bin or disable the entire machine.

The bar code in combination with articles of multiple articles being stored in a row or column in conjunction with not being able to view the article from the outside of the machine in combination with a selection graphic or button has a specific ability to prevent an operator from trying to cheat the system. By placing unauthorized goods intermingled with authorized goods, the user will have to assume that the product related to that selection graphic or button is all the same. If different items, some authorized and some not authorized, are both present within the same column, row or bin, the user will not find the result acceptable. This scenario is important since it allows more tolerance on part of the control system to interpolate that if some of the items in a bin are the correct ones, therefore the articles which may not be able to be scanned are most likely the same type of article.

In one embodiment of a multiple robot configuration may be contained within a warehousing structure. The system can utilize a common computer system to control all processes including conveyance, dispensing and monitoring whereby at least one conveyor system for moving a containment structure, such as a bag, basket, box or other type of container from one location to another, the system further having at least two robots are positioned so as to be operative to remove articles from storage bins (e.g. Typically articles of different types with different storage requirements) within the reach of the respective robots. The conveyor system which may be of many varied methods generally known can convey the container in order to allow the robots to place articles within their reach into the common bag or box prior to dispensing or conveying the container or box to a customer retrieval location. This customer retrieval location or locations can be remote to the housing structure that contains the article storage facilities and or the article conveyor systems. Additionally the other described aspects of the invention, such as article ID systems, control techniques and mechanical apparatus described herein may be applied to this embodiment. Other aspects that can be utilized advantageously here may be connection to a computer network such as the internet, LAN, WAN, Wireless etc. wherein a customer or user may monitor or order from the system. In one scenario, the user can order articles to be dispensed over the computer network and have them ready and waiting in a customer holding area so that the customer can retrieve the container or articles at a later time. A user can also use a touch screen in proximity to the automated dispensing system or retrieval area and or the remote computer system or network to check the inventory or availability of a specific item or items. In a further embodiment, This system can also be utilized as a mini warehouse system. In this scenario, the storage areas may contain articles or packages which are placed there specifically for access and retrieval by a certain person or entity. Using a passcode or access card or similar device or using a payment method, the user can retrieve packages such as parcels, letters, or other shipped goods from the storage area. This provides for a very convenient system since traditional deliveries to a person or entities home or place of business often requiring a physical signature and for a both parties to be present to receive and have the article delivered. Instead, the delivering party and the receiving party can use the article storage and dispensing apparatus as an exchange device allowing for the two parties to carry out the transfer of goods without having the requirement of being at the same place at the same time. Additionally, the use of a pass code or a swipe card, which may be connected to a gasoline pump, or any one of a multitude of devices, including biometric devices such as facial or fingerprint recognition, could be used as a verifiable electronic signature to ensure accountability. The elements described herein can be used in various other useful combinations which are considered part of the invention.

This dispensing apparatus can be used in locations such as Gas Station islands, parking lots or convenience stores etc. whereby products are delivered to customers from the dispensing apparatus, for example, using a pneumatic tube, or a conveyor system bringing articles from a remote storage area of the vending apparatus to a location on the perimeter of the apparatus housing, or to location external and or remote to the housing of the apparatus whereby the customer interface, such as a touch screen device and remote retrieval area can be accessed by the customer for remote delivery of articles conveyed and dispensed from the vending apparatus. The described invention can be used in an automated supermarket and such things as automated storerooms or stockrooms in office buildings and commercial locations.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. An article dispensing apparatus, comprising:
a storage volume for storing articles along a plurality of longitudinal axes;
an article extracting device including a free end for selectively extracting an article from the storage volume;
a positioning mechanism coupled to the article extracting device and responsive to control signals for positioning the free end of the device in alignment with a selected one of the longitudinal axes
a drive mechanism coupled to the article extracting device for moving the free end thereof in a direction aligned with the longitudinal axes in the storage area;
user interface and control apparatus for allowing a user of the dispensing apparatus to initiate an article dispensing operation, and to cause controlled movement of the article extracting device and the positioning mechanism so that a selected article is extracted from the article storage area and moves along a common path to a dispensing area of the dispensing apparatus, and
an article identification device, mounted within the dispensing apparatus, and operated so as to provide identification of an article before, during or after it moves along the common path,
wherein the article identification device uses optics to provide article identification, and is directed to image or scan the articles when they move in the common path,
wherein the article identification device comprises an imaging system, such as an analogue or digital, still or video, camera, coupled to an image analysis device that recognizes predetermined images (color/pattern or texture, etc.) thereby providing article identifications during the dispensing operation, and wherein the drive means causes the article extracting device to perform a predetermined movement in relation to the position of the article identification device, as the article moves from the article storage volume to the dispensing area.
